(19) United States
(12) Patent Application Publication
(10) Pub. No.: US 2013/0275143 A1
(43) Pub. Date: Oct. 17, 2013

(54) HEALTHCARE FINANCE MODEL

(71) Applicants: Michael A. CADGER, Sandy Springs, GA (US); James Purcell, Atlanta, GA (US)

(72) Inventors: Michael A. CADGER, Sandy Springs, GA (US); James Purcell, Atlanta, GA (US)

(73) Assignee: Monocle Health Data, LLC, Sandy Springs, GA (US)

(21) Appl. No.: 13/170,012

(22) Filed: Jun. 27, 2011

Related U.S. Application Data
(60) Provisional application No. 61/358,813, filed on Jun. 25, 2010.

(51) Int. Cl. G06F 19/00

(52) U.S. Cl. CPC G06F 19/328
USPC 705/2

(57) ABSTRACT

Systems, methods, and computer program products for implementing a healthcare finance model are disclosed. A method according to the present invention may be embodied in a computer program product. The method may include determining an expected price of a medical scenario for each of a set of providers. A predetermined ranking algorithm may be applied to the providers. Such ranking algorithm may consider at least an expected price of the medical scenario for each of the plurality of providers. The providers may be organized into two or more provider groups based on results of the ranking algorithm. Additionally, a flat insurance payment for service of the medical scenario may be established for each provider group based on their rankings. Providers within each single provider group may have the same insurance payment for the medical scenario.

### CROSS-REFERENCE TO RELATED APPLICATION

This application claims a benefit, under 35 U.S.C. § 119(e), of U.S. Provisional Application Ser. No. 61/358,813, filed 25 Jun. 2010, the entire contents and substance of which are hereby incorporated by reference.

### BACKGROUND

1. Technical Field

Various embodiments of the present invention relate to finance models and, more particularly, to finance models for healthcare insurance systems.

2. Description of Related Art

In current healthcare insurance systems, costs are unpredictable for both consumers as well as insurers.

With respect to consumers, a significant problem with present healthcare insurance systems is a lack of transparency of provider pricing. Consumers have no unbiased resource from which they can obtain straight-forward provider price comparisons. Therefore, a consumer may be unable to determine which providers will likely charge more, or less, than market averages. Market price averages are not readily available to the public and, when made available, are highly complex and fragmented. Before attempting to understand market price patterns, consumers must consolidate bits and pieces of information obtained from various resources. Unfortunately, consumers generally do not conduct the thorough research needed to consolidate and understand healthcare pricing information. As a result, a consumer will generally have no idea of the price of treating a diagnosis until after services have been rendered.

Like consumers, insurers do not necessarily have access to complete market pricing information. Insurers generally pay a negotiated rate, which is frequently a predetermined percentage of an artificial price for a service. This artificial price, referred to as the Usual,

Customary, and Reasonable (“UCR”) price, is established by insurers and is usually not based on market patterns. Indeed, healthcare insurers admitted to price-fixing in a February 2009 settlement between the New York General Attorney and various healthcare insurers. UCR price schedules do not represent true averages of net prices but are, instead, a complex function of the gross price of services (i.e., price before discounts).

Regulators have mandated that insurers use a transparency vehicle, such as the internet, to post their fee schedules. While this mandate promotes transparency, the mandate also presents greater complexity for self-insured employers and consumers. One of the reasons for the wide variance in pricing among providers is that different providers perform different sets of procedures for each medical scenario. For example, a first provider might perform a single sonogram during a normal, uncomplicated pregnancy. In contrast, a second provider might perform numerous sonograms on a similar pregnancy. Some of the sonograms performed by the second provider may be unnecessary, and may even be performed for the fraudulent purpose of receiving more money from the consumer and the insurer. Posted fee schedules enable the most diligent of consumers to compare provider pricing, but fail to inform consumers of which price variances are justified and which variances are unsupportable. Accordingly, current healthcare systems provide no mechanism for encouraging providers to provide quality service while keeping costs down.

Healthcare insurers have not yet established a pricing/reimbursement method to replace UCR and accurately reflect market prices. Additionally, due to price-fixing allegations, insurers cannot freely share price information with other insurers to determine true market pricing. As a result, each individual insurer must continue to use pricing that is based only on information received through claims filed with the individual insurer.

Accordingly, present healthcare insurance systems continue to produce untenable price disparities, and continue to encourage uninformed provider selection by consumers.

### SUMMARY

There is a need in the art for a healthcare finance model that enables consumers to select providers based on transparent pricing and known market norms. There is a further need in the art for a healthcare finance model that rewards providers who provide price-competitive services. In an exemplary embodiment, such a healthcare finance model may interject beneficial competition into the healthcare market. It is to such a healthcare finance model that embodiments of the present invention are directed.

Various embodiments of the invention are healthcare finance systems and methods. According to an exemplary embodiment of the present invention, a healthcare finance system may include data collection unit, a ranking unit, and a pricing unit.

The data collection unit may receive data related to actual past costs of health concerns, for each, specific procedures or treatment of entire medical scenarios. In an exemplary embodiment, a medical scenario may be a health concern the treatment of which generally requires more than a single visit or procedure, such as a chronic or non-acute concern. In a further exemplary embodiment, costs of a medical scenario may be determined with respect to a predetermined time period, such as a year. The data collection unit may receive data from various sources, such as from healthcare providers or from insurance companies who have access to actual costs charged by providers. Based on the data received, the data collection unit may establish an expected price for each of a plurality of health concerns. For example, the expected price of a particular health concern may be the average (i.e., mean, median, or mode) actual cost of the health concern. The data collection unit may also receive data related to the reputations of various providers. For example, and not limitation, data received may relate to censured, criminal charges, criminal convictions, lawsuits, education, training, certifications, or other data relevant to the quality of services provided by a medical professional. Additionally, the data collection unit may receive the prices currently set by each provider for each of various procedures and medical scenarios.

The ranking unit may rank the providers amongst each other by applying a predetermined ranking algorithm to the data gathered by the gathering unit. For each health concern, a different set of rankings may be provided, so that a provider's ranking may vary across different health concerns. Exemplarily, the rankings represent the values of the providers, where a high-quality and low-cost provider will be ranked above a high-quality and high-cost provider and above a low-quality and high-cost provider. In an exemplary embodiment, for each procedure or scenario, the algorithm may consider current pricing and historical quality of each provider. The historical quality may be determined by a quality metric that is based on data received related to the reputations of the providers. A second algorithm may be provided and utilized to determine a quality score for each provider, and this score may be considered in the ranking algorithm. After the providers are ranked for each health concern, the ranked list of providers may be divided into ranked groups, for example, quartiles.

The pricing unit may determine an insurance payment due to each provider for services related to a health concern. In an exemplary embodiment, each provider sets its own prices, and that price may be paid to the provider, preferably in full, by a combination of the insured's payment and the insurer's payment. Accordingly, the difference between a set price and the insurance payment may be the insured's responsibility. The insurance payment to a particular provider for services related to a health concern can be determined by a formula dependent on the expected price of services for the health concern and the ranked group of the provider in question. For example, the insurance payment for a provider can be set to a predetermined percentage of the expected price for the health concern, where the percentage is based on the ranked group of the provider. For further example, and not limitation, the insurance payment for the first (i.e., highest) ranked group can be a hundred percent of the expected price, while lower-ranked groups can receive lesser percentages of the expected price. It will be understood that the expected price may differ from the price set by a provider, and thus even if the insurance payment is the full expected price, the insured may still owe a payment to the provider to make up any difference between the set price and the expected price.

A website or other communication means can be provided to inform insureds of what they can expect to pay by using each provider to service a health concern. Because the prices of the providers are known, and because the ranking are known, the healthcare finance system can determine a cost to the insured for each health concern as serviced by each provider.

These and other objects, features, and advantages of the healthcare finance system will become more apparent upon reading the following specification in conjunction with the accompanying drawing figures.

### BRIEF DESCRIPTION OF THE FIGURES

FIG. 1 illustrates a diagram of a healthcare finance system, according to an exemplary embodiment of the present invention.

FIG. 2 illustrates an architecture of an exemplary computing device for the healthcare finance system, according to an exemplary embodiment of the present invention.

FIG. 3 illustrates a flow chart of a method of the healthcare finance system, according to an exemplary embodiment of the present invention.

FIGS. 4-10 illustrate screenshots of a website of the healthcare finance system, according to an exemplary embodiment of the present invention.

### DETAILED DESCRIPTION

To facilitate an understanding of the principles and features of the invention, various illustrative embodiments are explained below. In particular, the invention is described in the context of being a healthcare finance system for pricing services provided for health concerns. Embodiments of the invention, however, are not limited to this context. Rather, embodiments of the invention can be used for pricing various products and services, such as automobile repair or other services for which insurance is generally provided.

The components described hereinafter as making up various elements of the invention are intended to be illustrative and not restrictive. Many suitable components that would perform the same or similar functions as components described herein are intended to be embraced within the scope of the invention. Such other components not described herein can include, but are not limited to, for example, components developed after development of the invention.

Various embodiments of the present invention comprise healthcare finance systems and methods. Referring now to the figures, in which like reference numerals represent like parts throughout the views, various embodiments of the healthcare finance system will be described in detail.

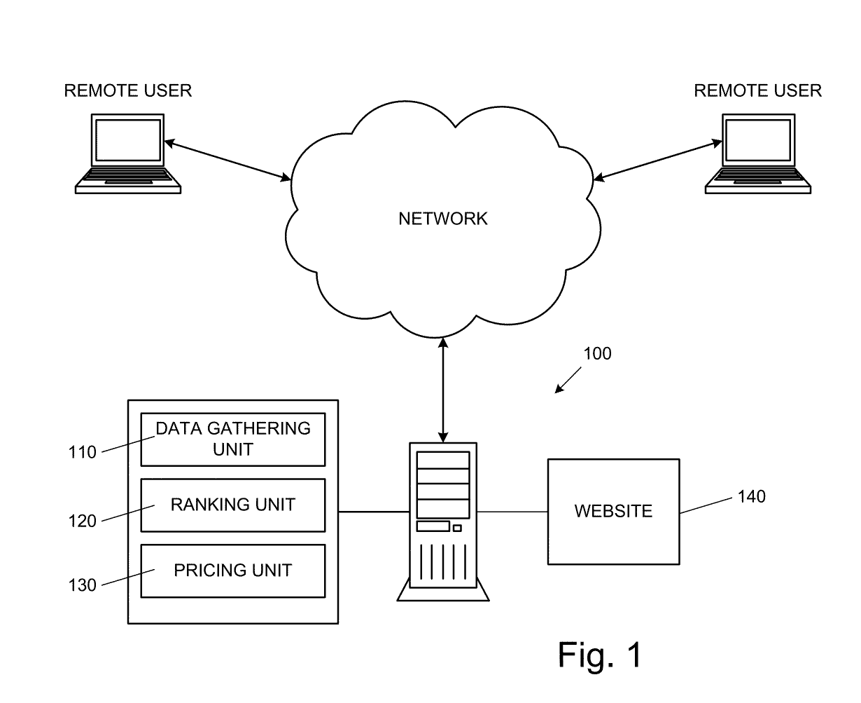

FIG. 1 illustrates a diagram of the healthcare finance system, according to an exemplary embodiment of the present invention. As shown in FIG. 1, the healthcare finance system 100 can comprise a data collection unit 110, a ranking unit 120, a pricing unit 130, and a website 140. The units of the healthcare finance system 100 can be programs, program modules, or other operative components of the healthcare finance system 100. Generally, the data collection unit can gather data related to past and current pricing of healthcare provider and can also gather data related to the quality and reputations of healthcare providers; the ranking unit can rank the provider according to a predetermined ranking algorithm, and can then group the providers according to the rankings; and the pricing unit 130 can calculate an insurance payment and insured payment for one or more healthcare concerns as serviced by specific providers. The website can provide pricing information to remote users upon request.

Some exemplary embodiments of the healthcare finance model comprise determining provider prices for various medical scenarios based on a value-ranking algorithm applied to the providers. Depending on the situation, the provider prices may be paid by consumers, insurers, or a combination of consumers and insurers. For purposes of the healthcare finance model, providers may include, for example, doctors, hospitals, pharmacies, laboratories, imaging professionals, therapists, and various other providers of health-related services. Insurers may include traditional insurance companies, as well as self-insured employers, third-party administrators, and various other entities equipped to adjudicate claims and process health-related reimbursements. Finally, consumers may be various individuals seeking or receiving health-related services from providers.

A system incorporating the healthcare finance model may have access to data relating to various providers participating in the system. This data may, for example, be extracted from insurance claims data received from insurers. A value-ranking algorithm ranks the providers based on the received data.

The value-ranking algorithm may consider various factors related to each provider. Such factors may include, without limitation, an expected cost of a medical scenario, an expected set of procedures included in the medical scenario, expected number of office visits for the medical scenario, mortality rates for the medical scenario, and other factors. Based on a combination of the factors considered, the value-ranking algorithm may rank the providers. The ranked providers may then be divided into groups based on their rankings. For example, the providers may be divided into four quartiles, where the first quartile represents the greatest value (e.g., lowest prices, highest quality services), and the fourth quartile represents the least value (e.g., highest prices, lowest quality services). Alternatively, the providers may be divided into quintiles, deciles, or various other groupings. The value-ranking algorithm may produce a different set of rankings for each medical scenario, specialty, market, or other practical division. Accordingly, provider groupings may vary across medical scenarios, specialties, markets, and other divisions. In an exemplary embodiment, each group has an approximately equal number of providers, but this need not be the case.

Providers may set their own prices, and each provider may expect to receive a total payment for a medical scenario equal to the price set by that provider. Embodiments of the healthcare finance model may determine how the total payment of such a price is divided amongst various parties, such as a consumer and the consumer's insurer.

An insurer payment, or reimbursement, to a provider for service of a medical scenario may be a function of a target price. The insurer payment may also depend on the provider's group according to the value-ranking algorithm. In an exemplary embodiment, the target price is not an artificial price manufactured by insurers. Instead, the target price may reflect actual market pricing, which may be determined from insurance claims data received from insurers.

For example, the target price for a medical scenario may be set to the average or median market price for the medical scenario.

Suppose, for example, that the providers are grouped into quartiles, with the first quartile representing the highest ranked providers. In an exemplary embodiment, the insurer payment is less in a lower-ranked quartile than in a higher-ranked quartile. For example, the insurer payment may be over 100% of the target price for a first quartile provider, 100% of the target price for a second quartile provider, 80% of the target price for a third quartile provider, and 70% of the target price for a fourth quartile provider.

The consumer's insurer tenders the insurer payment to the provider. Because the target price is a known value, and the insurer payment is known function of the target price, insurers may more effectively estimate payouts to providers as compared to current healthcare systems. Additionally, because higher quartile providers receive higher payments from insurers, providers are encouraged to provide more valuable services to consumers.

The consumer may be responsible for paying the difference between the provider's price and the insurance payment to the provider. As a result, the consumer may bear a greater cost burden by selected a provider in a lower-ranked group than would be borne if the consumer selecting a provider in a higher-ranked group. For example, if the consumer receives services from a first quartile provider, the consumer may bear no cost from receipt of such services. In contrast, if the consumer receives services from a fourth quartile provider, the consumer may owe a larger payment than would be owed for services from a third, second, or first quartile provider.

In an exemplary embodiment of the healthcare finance model, consumers may access provider rankings, groupings, and pricing data. Accordingly, consumers may investigate the quality, value, and pricing of various providers. A system implementing an exemplary embodiment of the healthcare finance model may provide a consumer with data related to precise prices of services and, further, which portion of such costs are the responsibility of the consumer. Accordingly, consumers may have access to information regarding competitive pricing of providers for a medical scenario. As a result, consumers can select providers based on informed decisions.

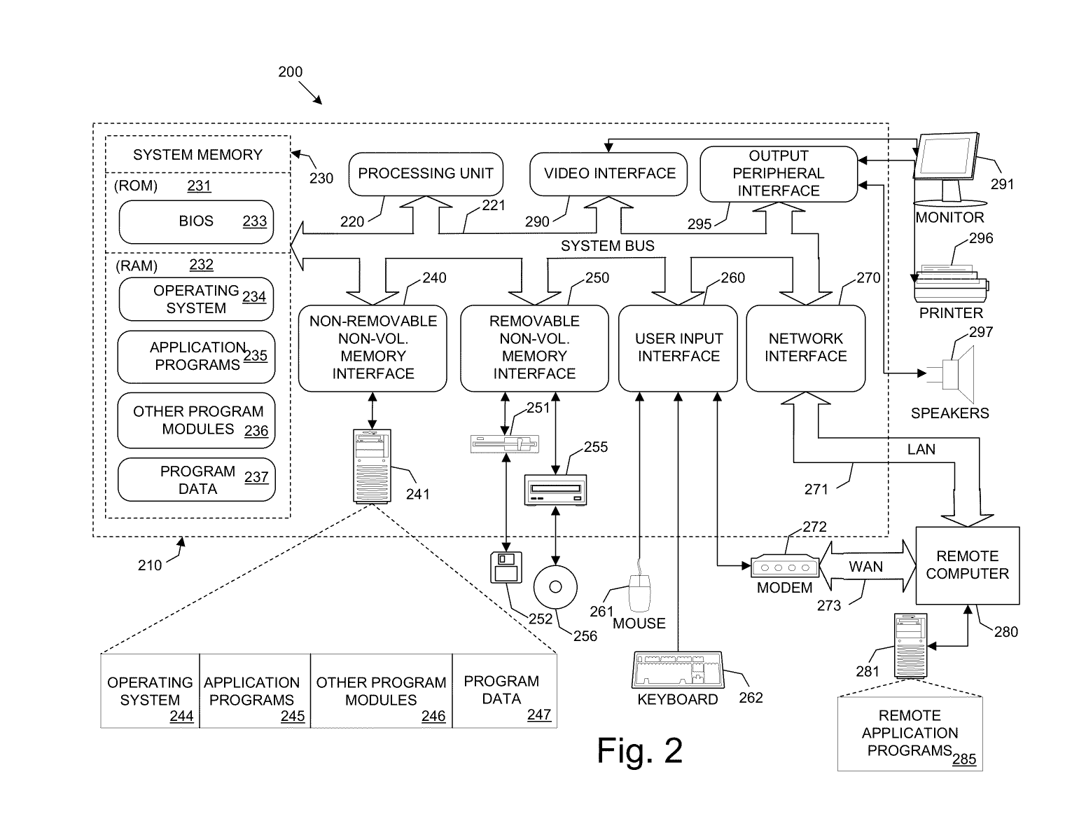

The healthcare finance model may be implemented in various manners. For example, and not limitation, the healthcare finance model may be embodied in a system, such as a computer or network system, a method, or a computer program product. If implemented in a computer program product, various aspects of the healthcare finance model may be embodied in computer-readable instructions for execution by a processor of a computing device. FIG. 2 illustrates such a computing device, according to an exemplary embodiment of the present invention.

FIG. 2 illustrates an example of a suitable computing device 200 that can be used as or can comprise a portion of an exemplary embodiment of the healthcare finance system 100. Although specific components of a computing device 200 are illustrated in FIG. 2, the depiction of these components in lieu of others does not limit the scope of the invention. Rather, various types of computing devices 200 can be used to implement embodiments of the healthcare finance system 100. Exemplary embodiments of the healthcare finance system 100 can be operational with numerous other general purpose or special purpose computing system environments or configurations. Examples of well known computing systems, environments, and/or configurations that can be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 2, components of the computing device 200 can comprise, without limitation, a processing unit 220 and a system memory 230. A system bus 221 can couple various system components including the system memory 230 to the processing unit 220. The system bus 221 can be any of several types of bus structures including a memory bus or memory controller, a peripheral bus, and a local bus using any of a variety of bus architectures. By way of example, and not limitation, such architectures can include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 200 can include a variety of computer readable media. Computer-readable media can be any available media that can be accessed by the computing device 200, including both volatile and nonvolatile, removable and non-removable media. For example, and not limitation, computer-readable media can comprise computer storage media and communication media. Computer storage media includes both volatile and nonvolatile, removable and non-removable media implemented in any method or technology for storage of information such as computer readable instructions, data structures, program modules or other data. Computer storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store data accessible by the computing device 200.

Communication media can typically contain computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, and not limitation, communication media includes wired media such as a wired network or direct-wired connection, and wireless media such as acoustic, RF, infrared and other wireless media. Combinations of any of the above can also be included within the scope of computer readable media.

The system memory 230 can comprise computer storage media in the form of volatile and/or nonvolatile memory such as read only memory (ROM) 231 and random access memory (RAM) 232. A basic input/output system 233 (BIOS), containing the basic routines that help to transfer information between elements within the computing device 200, such as during start-up, can typically be stored in the ROM 231. The RAM 232 typically contains data and/or program modules that are immediately accessible to and/or presently in operation by the processing unit 220. For example, and not limitation, FIG. 2 illustrates operating system 234, application programs 235, other program modules 236, and program data 237.

The computing device 200 can also include other removable/non-removable, volatile/nonvolatile computer storage media. By way of example only, FIG. 2 illustrates a hard disk drive 241 that can read from or write to non-removable, nonvolatile magnetic media, a magnetic disk drive 251 for reading or writing to a nonvolatile magnetic disk 252, and an optical disk drive 255 for reading or writing to a nonvolatile optical disk 256, such as a CD ROM or other optical media. Other removable/non-removable, volatile/nonvolatile computer storage media that can be used in the exemplary operating environment can include magnetic tape cassettes, flash memory cards, digital versatile disks, digital video tape, solid state RAM, solid state ROM, and the like. The hard disk drive 241 can be connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2 can provide storage of computer readable instructions, data structures, program modules and other data for the computing device 200. For example, hard disk drive 241 is illustrated as storing an operating system 244, application programs 245, other program modules 246, and program data 247. These components can either be the same as or different from operating system 234, application programs 235, other program modules 236, and program data 237.

A web browser application program 235, or web client, can be stored on the hard disk drive 241 or other storage media. The web client 235 can request and render web pages, such as those written in Hypertext Markup Language (“HTML”), in another markup language, or in a scripting language. The web client 235 can be capable of executing client-side objects, as well as scripts within the browser environment. Additionally, the web client 235 can execute web application programs, which can be embodied in web pages.

A user of the computing device 200 can enter commands and information into the computing device 200 through input devices such as a keyboard 262 and pointing device 261, commonly referred to as a mouse, trackball, or touch pad. Other input devices (not shown) can include a microphone, joystick, game pad, satellite dish, scanner, electronic white board, or the like. These and other input devices are often connected to the processing unit 220 through a user input interface 260 coupled to the system bus 221, but can be connected by other interface and bus structures, such as a parallel port, game port, or a universal serial bus (USB). A monitor 291 or other type of display device can also be connected to the system bus 221 via an interface, such as a video interface 290. In addition to the monitor, the computing device 200 can also include other peripheral output devices such as speakers 297 and a printer 296. These can be connected through an output peripheral interface 295.

The computing device 200 can operate in a networked environment, being in communication with one or more remote computers 280 over a network 50. The remote computer 280 can be a personal computer, a server, a router, a network PC, a peer device, or other common network node, and can include many or all of the elements described above relative to the computing device 200, including a memory storage device 281. The network 50 can comprise the Internet, a local area network (LAN) 271, a wide area network (WAN) 273, or one or more other networks.

When used in a LAN networking environment, the computing device 200 can be connected to the LAN 271 through a network interface or adapter 270. When used in a WAN networking environment, the computing device 200 can include a modem 272 or other means for establishing communications over the WAN 273, such as the internet. The modem 272, which can be internal or external, can be connected to the system bus 221 via the user input interface 260 or other appropriate mechanism. In a networked environment, program modules depicted relative to the computing device 200 can be stored in the remote memory storage device. For example, and not limitation, FIG. 2 illustrates remote application programs 285 as residing on memory storage device 281. It will be appreciated that the network connections shown are exemplary and other means of establishing a communications link between the computers can be used.

Referring back to FIG. 1, the data collection unit may receive data related to actual past costs of health concerns, for each, specific procedures or treatment of entire medical scenarios. In an exemplary embodiment, a medical scenario may be a health concern the treatment of which generally requires more than a single visit or procedure, such as a chronic or non-acute concern. In a further exemplary embodiment, costs of a medical scenario may be determined with respect to a predetermined time period, such as a year. The data collection unit may receive data from various sources, such as from healthcare providers or from insurance companies who have access to actual costs charged by providers. Based on the data received, the data collection unit may establish an expected price for each of a plurality of health concerns. For example, the expected price of a particular health concern may be the average (i.e., mean, median, or mode) actual cost of the health concern. The data collection unit may also receive data related to the reputations of various providers. For example, and not limitation, data received may relate to censured, criminal charges, criminal convictions, lawsuits, education, training, certifications, or other data relevant to the quality of services provided by a medical professional. Additionally, the data collection unit may receive the prices currently set by each provider for each of various procedures and medical scenarios.

The ranking unit may rank the providers amongst each other by applying a predetermined ranking algorithm to the data gathered by the gathering unit. For each health concern, a different set of rankings may be provided, so that a provider's ranking may vary across different health concerns. Exemplarily, the rankings represent the values of the providers, where a high-quality and low-cost provider will be ranked above a high-quality and high-cost provider and above a low-quality and high-cost provider. In an exemplary embodiment, for each procedure or scenario, the algorithm may consider current pricing and historical quality of each provider. The historical quality may be determined by a quality metric that is based on data received related to the reputations of the providers. A second algorithm may be provided and utilized to determine a quality score for each provider, and this score may be considered in the ranking algorithm.

After the providers are ranked for each health concern, the ranked list of providers may be divided into ranked groups, for example, quartiles.

The pricing unit may determine an insurance payment due to each provider for services related to a health concern. In an exemplary embodiment, each provider sets its own prices, and that price may be paid to the provider, preferably in full, by a combination of the insured's payment and the insurer's payment. Accordingly, the difference between a set price and the insurance payment may be the insured's responsibility. The insurance payment to a particular provider for services related to a health concern can be determined by a formula dependent on the expected price of services for the health concern and the ranked group of the provider in question. For example, the insurance payment for a provider can be set to a predetermined percentage of the expected price for the health concern, where the percentage is based on the ranked group of the provider. For further example, and not limitation, the insurance payment for the first (i.e., highest) ranked group can be a hundred percent of the expected price, while lower-ranked groups can receive lesser percentages of the expected price. It will be understood that the expected price may differ from the price set by a provider, and thus even if the insurance payment is the full expected price, the insured may still owe a payment to the provider to make up any difference between the set price and the expected price.

The website, or other communication means, can be provided to inform insureds of what they can expect to pay by using each provider to service a health concern. Because the prices of the providers are known, and because the ranking are known, the healthcare finance system can determine a cost to the insured for each health concern as serviced by each provider.

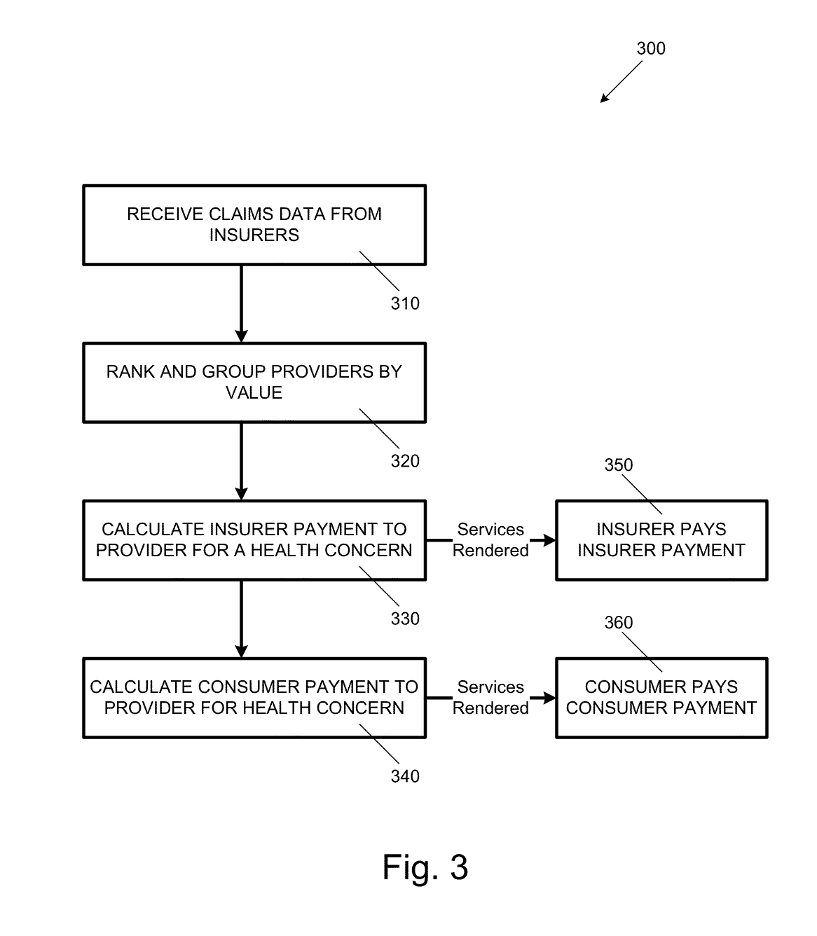

FIG. 3 illustrates a flow chart of a method 300 of a method of pricing a health concern, according to an exemplary embodiment of the present invention. As illustrated, at 310, data may be received from insurance companies. Such data may include information relating to past insurance claims. Similar data may also be received from other organizations having knowledge regarding prices charged by providers. At 320, the received data may be used to rank and group providers. Providers may be ranked according to a predetermined algorithm. For example, the algorithm may rank the providers based on price or, alternatively, based on price in combination with one or more other factors. For ranking purposes, provider prices may be determined from claims data received from one or more insurers or other price data resources. Based on their rankings, the providers may be organized into two or more groups. At 330, an insurer payment amount may be determined for services provided for a health concern. Services for the health concern may be, for example, a single medical service or a series of services directed to a common task or diagnosis. As discussed above, the insurer payment may be related to a provider's group, and may represent a function of the target price for the service. At 340, a consumer payment amount for provision the scenario by a specific provider may be determined.

In an exemplary embodiment, the consumer payment may be a function of the price set by the provider, the insurance payment, the target price for the scenario, or a combination thereof. For example, if the provider's set price exceeds the insurance payment, the consumer payment may be the provider's price less the insurance payment. When services pertaining to the scenario are rendered, the provider receives payment for such services. At 350, the insurer pays the insurance payment for the scenario, and at 360, the consumer pays the consumer payment for the scenario.

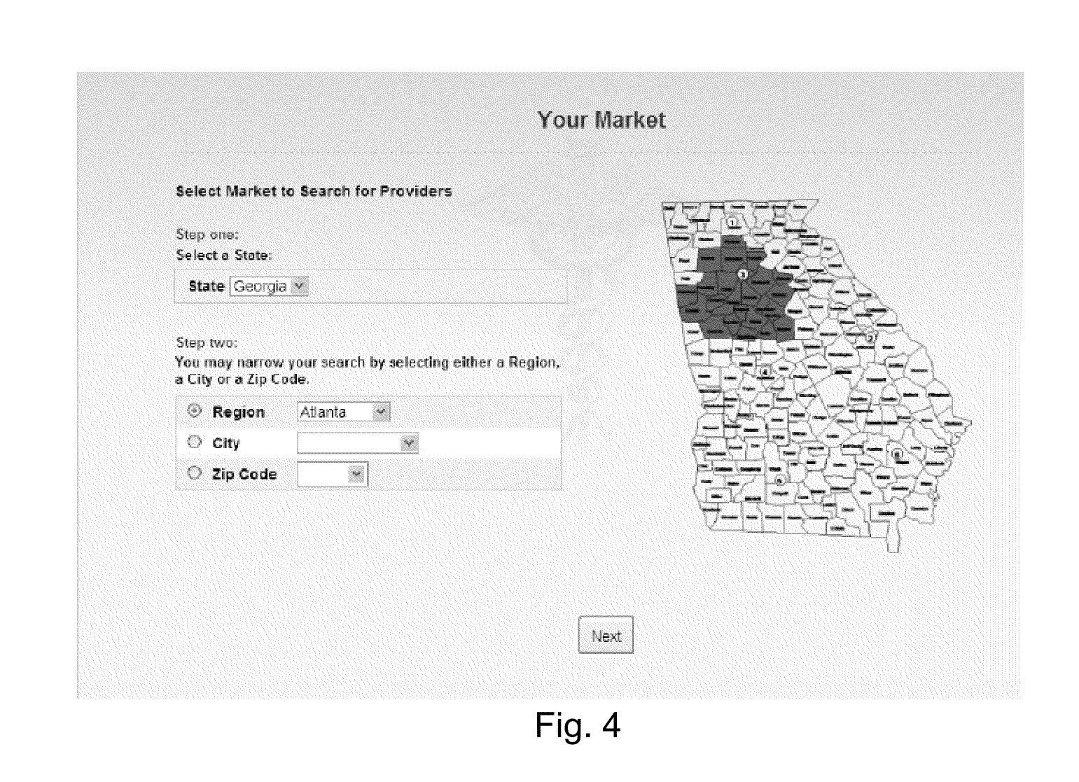

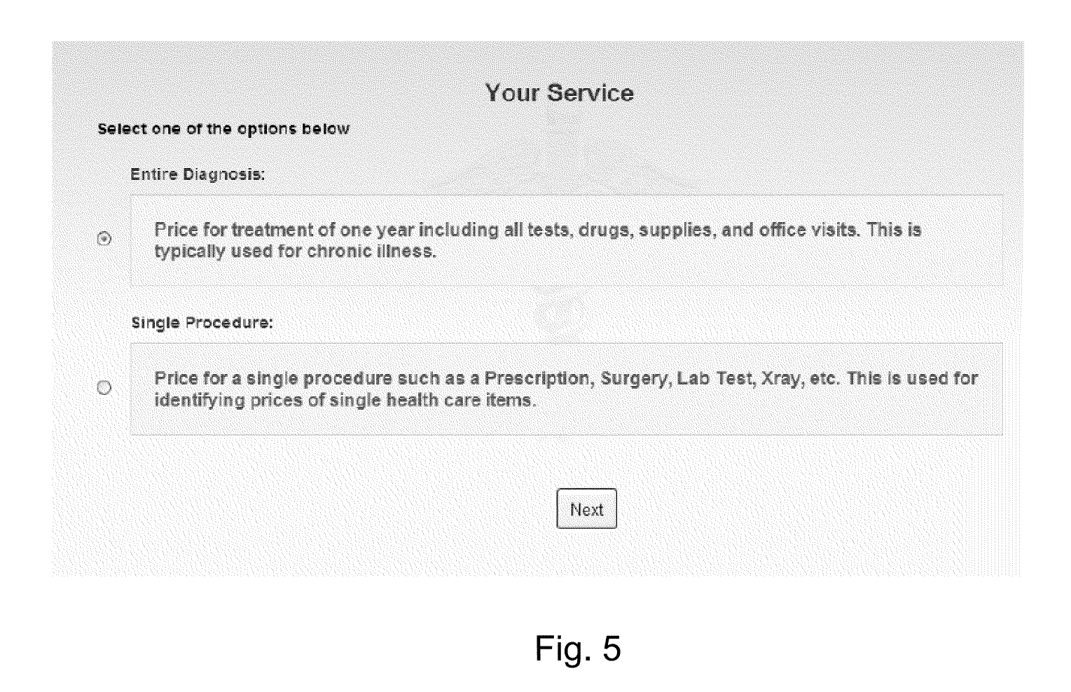

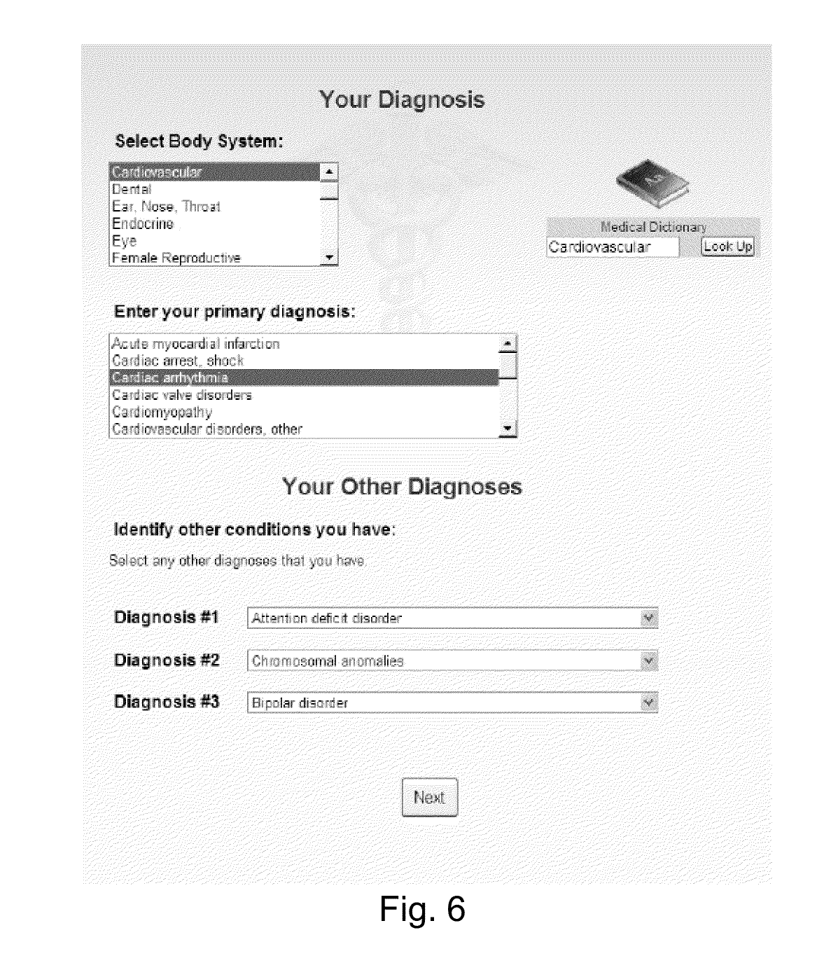

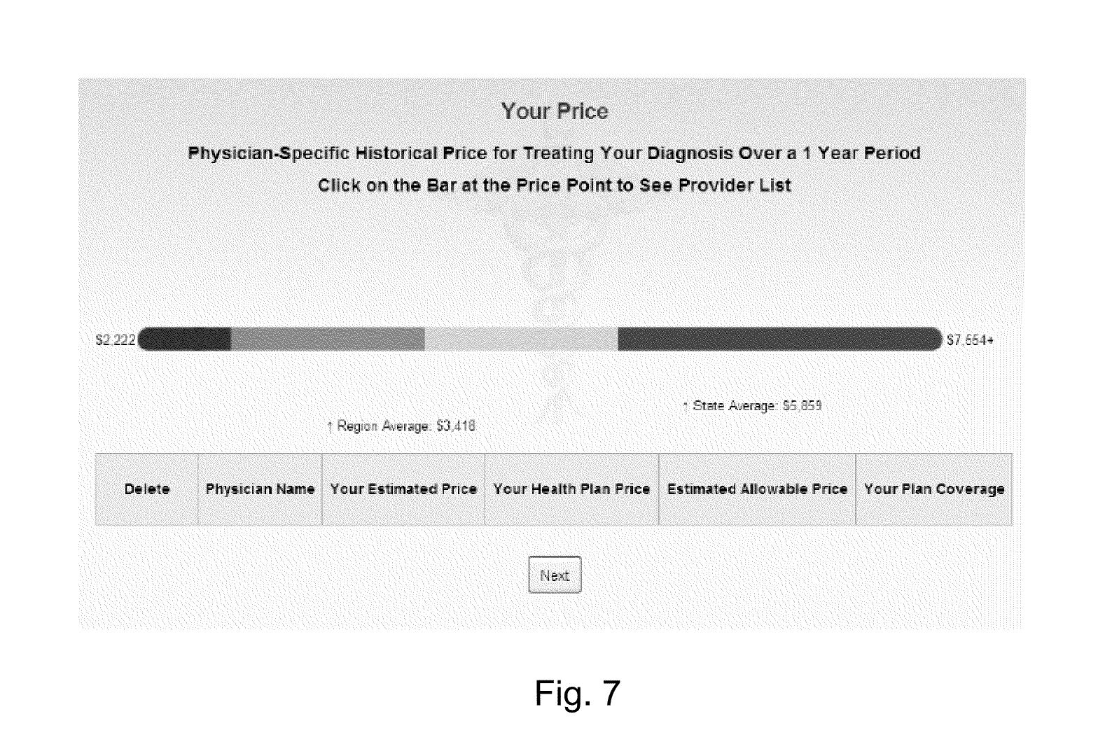

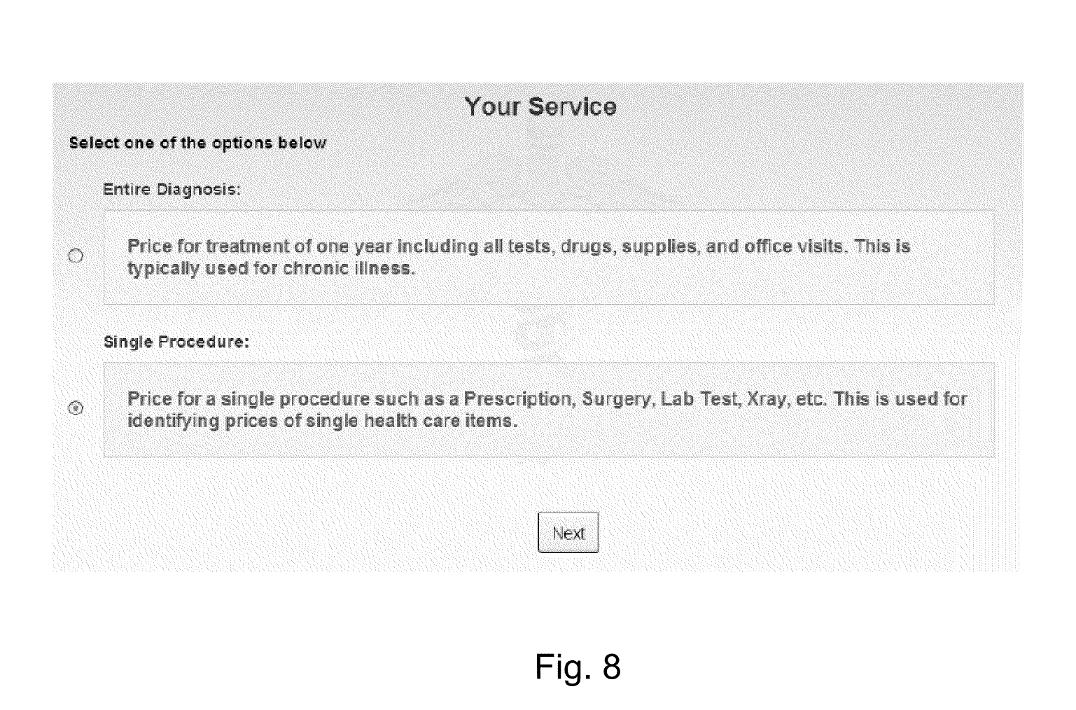

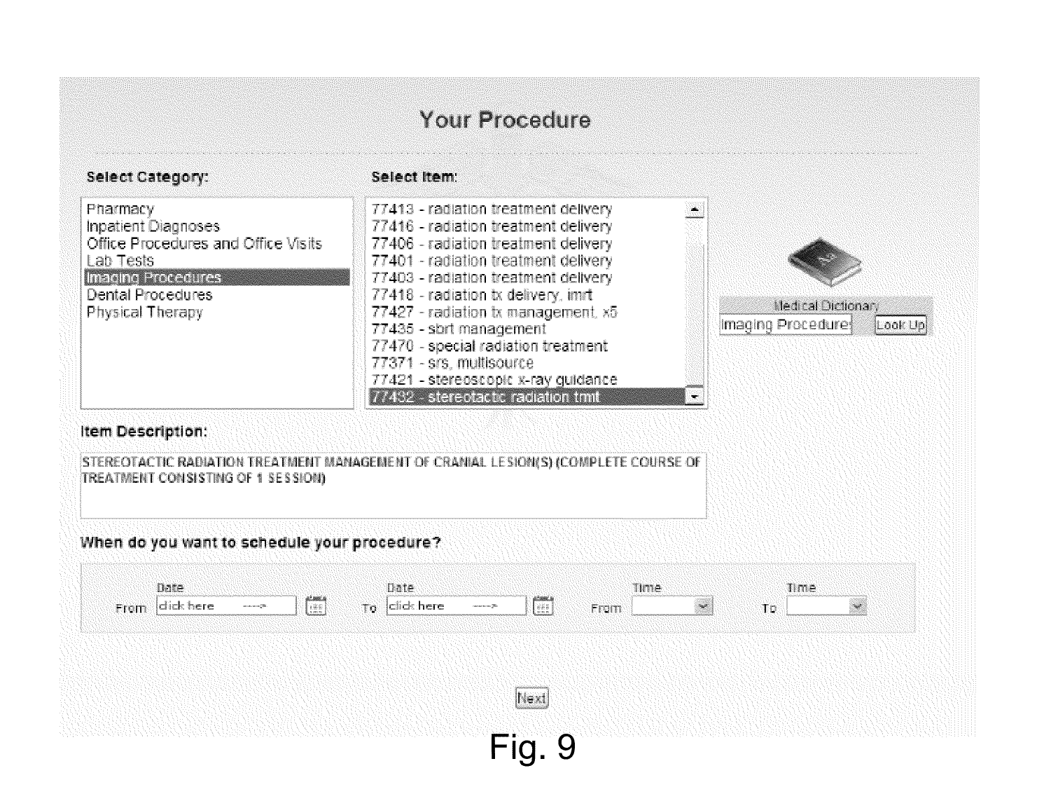

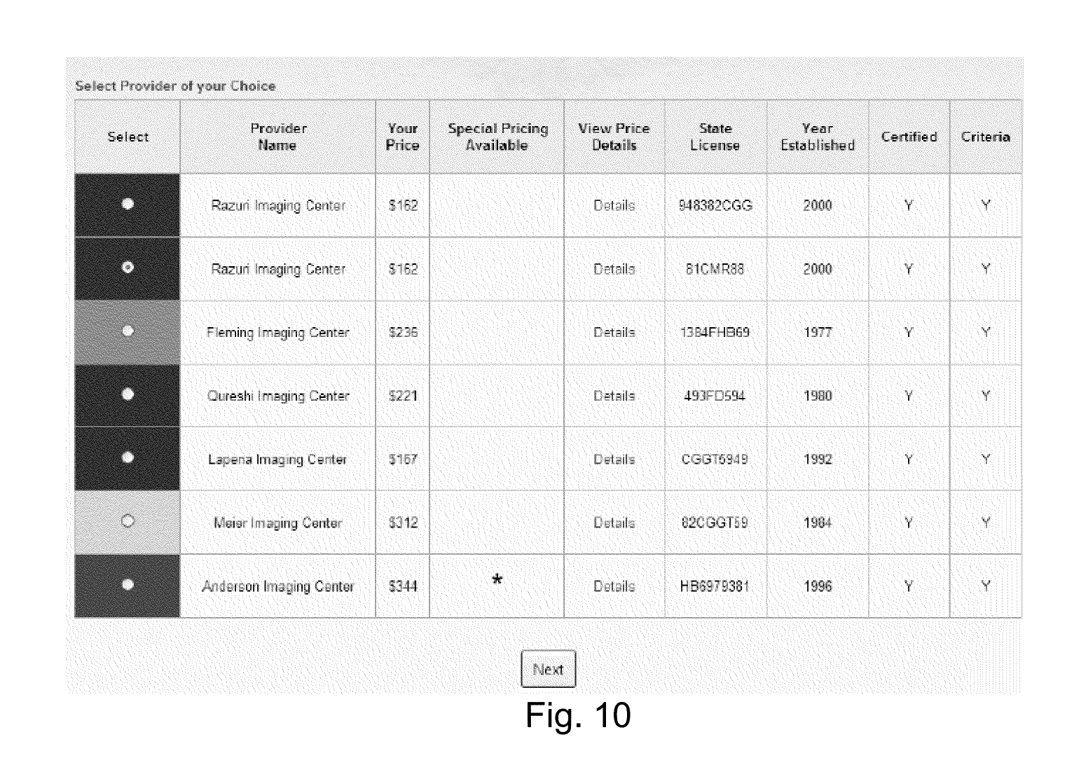

FIGS. 4-10 illustrate screenshots of a website of the healthcare finance system, according to an exemplary embodiment of the present invention. These screenshots do not limit the various embodiments of the present invention but instead are provided only for illustrative purposes.

While various embodiments of the healthcare finance system and method have been disclosed in exemplary forms, it will be apparent to those skilled in the art that many modifications, additions, and deletions can be made without departing from the spirit and scope of the system, method, and their equivalents, as set forth in the following claims.

1. A computer-readable medium having computer readable instructions stored thereon for execution by a processor to execute a healthcare finance method comprising:
determining an expected price of a medical scenario for each of a plurality of providers;
ranking the plurality of providers according to a predetermined ranking algorithm considering at least the expected prices of the medical scenario;
organizing the plurality of providers into two or more provider groups based on results of the ranking algorithm; and
determining an insurance payment to each provider for the medical scenario, wherein the insurance payment to a first provider is based on a target price and the provider group of the first provider.

2. The computer-readable medium of claim 1, wherein determining the expected price of the medical scenario comprises obtaining insurance claims data from two or more insurers.

3. The computer-readable medium of claim 1, the ranking algorithm further considering a cost-effectiveness of providing care in the medical scenario for each of the plurality of providers.

4. The computer-readable medium of claim 1, wherein determining an expected cost of the medical scenario for each of the plurality of providers comprises receiving insurance claims data from a plurality of insurers.

5. The computer-readable medium of claim 1, further comprising calculating a consumer cost of service of the medical scenario for a selected provider, the consumer cost of service being a difference between a provider-specific cost set by the selected provider and the insurer cost of service for a provider group corresponding to the selected provider.

6. The computer-readable medium of claim 5, further comprising displaying a consumer cost of service of the medical scenario for the selected provider.

7. The computer-readable medium of claim 1, further comprising determining a target total cost for the medical scenario.

8. The computer-readable medium of claim 7, the target total cost comprising a median cost of the medical scenario among the plurality of providers.

9. The computer-readable medium of claim 7, the flat insurer cost of service for the medical scenario for a first provider group comprising a first predetermined percentage of the median cost.

10. The computer-readable medium of claim 9, the flat insurer cost of service for the medical scenario for a second provider group comprising a second predetermined percentage of the median cost, wherein the first predetermined percentage is higher than the second predetermined percentage if providers in the first provider group have preferred rankings over providers in the second provider group.
